(19) United States
(12) Patent Application Publication
(10) Pub. No.: US 2025/0350984 A1
(43) Pub. Date: Nov. 13, 2025

(54) CROSS LINK INTERFERENCE CONTROL FOR PASSIVE RADIO FREQUENCY DEVICES

(71) Applicant: QUALCOMM Incorporated, San Diego, CA (US)

(72) Inventors: Zhikun WU, Beijing (CN); Huilin XU, Temecula, CA (US); Ahmed ELSHAFIE, San Diego (UA); Yuchul KIM, San Diego, CA (US); Yu ZHANG, San Diego, CA (US); Linhai HE, San Diego, CA (US); Seyedkianoush HOSSEINI, San Diego, CA (US)

(21) Appl. No.: 18/867,567

(22) PCT Filed: Jul. 13, 2022
(86) PCT No.: PCT/CN2022/105397

§ 371 Date: Nov. 20, 2024

(51) Int. Cl. H04W 24/10; H04B 17/318

(52) U.S. Cl. CPC H04W 24/10; H04B 17/328

(57) ABSTRACT

Systems and methods for CLI in a wireless communication system with a passive RF device are provided. A user equipment (UE) in communication with a passive RF device such as a passive RFID tag may receive a command from a base station (BS) to generate an interference report. The UE may configure the passive RF device to turn on and off and make measurements during each of the states in order to determine the relative received power levels. Based on the difference between the received power levels associated with each state, the UE may transmit an interference report to the BS. The BS may configure subsequent communication with the UE in order to mitigate cross link interference based on the interference report.

### TECHNICAL FIELD

This application relates to wireless communication devices, systems, and methods, and more particularly to devices, systems, and methods for mitigating cross link interference associated with passive RF devices.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long term evolution (LTE) technology to a next generation new radio (NR) technology, which may be referred to as 5th Generation (5G), designed to provide a lower latency, a higher bandwidth or a higher throughput, and a higher reliability than LTE.

UEs in some networks may include the capability to communicate with passive internet of things (IoT) devices such as passive radio frequency identification (RFID) tags (generally, passive RF devices). Cross link interference associated with passive RF devices is not accounted for in existing cross link interference mitigation techniques, which rely on the interference being associated with active devices instead of passive devices. Moreover, there are currently no approaches for distinguishing between direct or reflected cross link interference. Therefore, there is a need in the art for improved cross link interference mitigation systems and methods associated with passive RF devices.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

One aspect of the present disclosure includes a method of wireless communication performed by a user equipment (UE), the method comprising transmitting, to a passive radio frequency (RF) device, a first message to enter a non-reflective state. The method further comprises performing a first interference measurement while the passive RF device is in the non-reflective state. The method further comprises transmitting, to the passive RF device, a second message to enter a reflective state. The method further comprises performing a second interference measurement while the passive RF device is in the reflective state. The method further comprises transmitting an interference report to a wireless communication device based on the first interference measurement and the second interference measurement.

Another aspect of the present disclosure includes a method of wireless communication performed by a wireless communication device, the method comprising transmitting, to a first user equipment (UE), a command to provide an interference report. The method further comprises transmitting, to a second UE, a first message scheduling the second UE to transmit a reference signal. The method further comprises receiving the interference report from the first UE based on a first interference measurement of the reference signal and a second interference measurement of the reference signal.

Another aspect of the present disclosure includes a user equipment (UE), comprising a transceiver configured to transmit, to a passive radio frequency (RF) device, a first message to enter a non-reflective state. The transceiver is further configured to perform a first interference measurement while the passive RF device is in the non-reflective state. The transceiver is further configured to transmit, to the passive RF device, a second message to enter a reflective state. The transceiver is further configured to perform a second interference measurement while the passive RF device is in the reflective state. The transceiver is further configured to transmit an interference report to a wireless communication device based on the first interference measurement and the second interference measurement.

Another aspect of the present disclosure includes a wireless communication device, comprising a transceiver configured to transmit, to a first user equipment (UE), a command to provide an interference report. The transceiver is further configured to transmit, to a second UE, a first message scheduling the second UE to transmit a reference signal. The transceiver is further configured to receive the interference report from the first UE based on a first interference measurement of the reference signal and a second interference measurement of the reference signal.

Other aspects, features, and embodiments will become apparent to those of ordinary skill in the art, upon reviewing the following description of specific, exemplary aspects in conjunction with the accompanying figures. While features may be discussed relative to certain aspects and figures below, all aspects can include one or more of the advantageous features discussed herein. In other words, while one or more aspects may be discussed as having certain advantageous features, one or more of such features may also be used in accordance with the various aspects discussed herein. In similar fashion, while exemplary aspects may be discussed below as device, system, or method aspects it should be understood that such exemplary aspects can be implemented in various devices, systems, and methods.

### BRIEF DESCRIPTION OF THE DRAWINGS

FIG. 1 illustrates a wireless communication network according to some aspects of the present disclosure.

FIG. 2 illustrates an example portion of a wireless communications system that supports RU sharing techniques in wireless communications according to some aspects of the present disclosure.

FIG. 3 illustrates a diagram of a system including a device that supports RU sharing techniques in wireless communications according to some aspects of the present disclosure.

FIG. 4 illustrates an example wireless communication network according to some aspects of the present disclosure.

FIG. 5 illustrates an example wireless communication network according to some aspects of the present disclosure.

FIG. 6 illustrates an example sequence diagram according to some aspects of the present disclosure.

FIG. 7 is a signaling diagram according to some aspects of the present disclosure.

FIG. 8 illustrates a block diagram of a network unit according to some aspects of the present disclosure.

FIG. 9 illustrates a block diagram of a user equipment (UE) according to some aspects of the present disclosure.

FIG. 10 is a flow diagram of a wireless communication method performed by a user equipment according to some aspects of the present disclosure.

FIG. 11 is a flow diagram of a wireless communication method performed by a network unit according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some aspects, well-known structures and components are shown in block diagram form in order to avoid obscuring such concepts.

This disclosure relates generally to wireless communications systems, also referred to as wireless communications networks. In various aspects, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5th Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an Ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜ 1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

A 5G NR communication system may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW. In certain aspects, frequency bands for 5G NR are separated into multiple different frequency ranges, a frequency range one (FR1), a frequency range two (FR2), and FR2x. FR1 bands include frequency bands at 7 GHz or lower (e.g., between about 410 MHz to about 7125 MHz). FR2 bands include frequency bands in mmWave ranges between about 24.25 GHz and about 52.6 GHz. FR2x bands include frequency bands in mmWave ranges between about 52.6 GHz to about 71 GHz. The mmWave bands may have a shorter range, but a higher bandwidth than the FR1 bands. Additionally, 5G NR may support different sets of subcarrier spacing for different frequency ranges.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The present disclosure describes systems and methods for mitigating cross link interference (CLI) associated with passive internet of things (IoT) devices including passive RF devices such as passive RFID tags. Passive RF devices may communicate with other devices using backscatter, which is a controlled reflection of an incoming signal. However, this reflectivity of the passive RF device may also reflect signals that would be considered interference by a receiver. Passive RF devices generally do not have the capability of characterizing a channel, or performing interference control. It may be beneficial to a network to measure cross link interference associated with a passive RF device, and report that measurement to a network unit such as a base station (BS).

One difficulty in characterizing the interference associated with a passive RF device, is determining what amount of interference is caused by signals reflected by the passive RF device (also referred to herein as reflected cross-link interference), versus direct cross-link interference from another, interfering source. Methods described herein resolve this problem by making multiple interference measurements. A BS may request that a UE in communication with a passive RF device toggle that passive RF device between powered on and powered off, or more generally reflective and non-reflective states. While the passive RF device states are toggling, the BS itself or another device may be configured to be transmitting a reference signal. The UE may measure the level of interference when the passive RF device is in a non-reflective state, as well as when the passive RF device is in a reflective state.

By taking the difference between the measurements, the UE or BS may determine the relative contributions of reflected interference and direct interference. This information may then be used to configure network communications in order to avoid excessive interference. For example, when the direct interference is above a predetermined threshold, the UE in communication with the passive RF device which is receiving the interference (i.e., the victim UE) may not be scheduled to communicate with the passive RF device while the device which is transmitting the interfering signal (i.e., the aggressor) is communicating. In another example, when the reflected interference is above a predetermined threshold, the victim UE may configure the passive RF device to a non-reflective state, allowing another device such as the BS to communicate with the UE without excessive interference.

Systems and methods described herein provide many advantages. By determining the contribution of reflected and direct interference, a network unit may more intelligently make adjustments to network configuration and/or scheduling in order to mitigate the interference. Additionally, putting the passive RF device in a non-reflective state based on the interference measurements allows a UE to communicate with another device when it otherwise would not have been able to reliably communicate. By enabling low power passive RF devices to communicate effectively in a network as described herein, overall lower power consumption may be achieved.

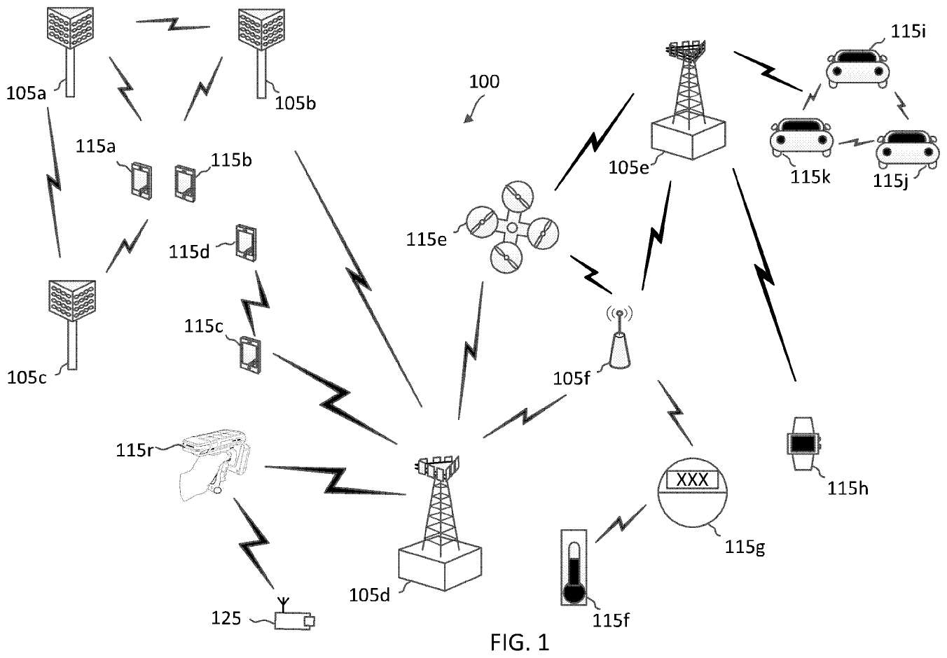

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 (individually labeled as 115a, 115b, 115c, 115d, 115e, 115f, 115g, 115h, and 115k) and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices (e.g., including passive RF devices as discussed further herein). The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (COMP) or multi-connectivity. The macro BS 105d may perform backhaul communications with the BSs 105a-105c, as well as small cell, the BS 105f. The macro BS 105d may also transmit multicast services which are subscribed to and received by the UEs 115c and 115d. Such multicast services may include mobile television or stream video, or may include other services for providing community information, such as weather emergencies or alerts, such as Amber alerts or gray alerts.

BS 105d may also communicate with a reader 115r. Reader 115r may be a UE 115 with passive RF device communication capability. Reader 115r may be a device with more dedicated functionality such as a dedicated RFID reader. Tag 125 is a passive RF device which may communicate with reader 115r, for example via backscatter communication. Backscatter communication relies on reader 115r or another device to transmit a signal, which is selectively reflected by tag 125 in a pattern which encodes information. Tag 125 may include one or more non-reflective modes which may limit or eliminate reflections. For example, tag 125 may be turned off by electrically disconnected a power source from all or a portion of the device. Tag 125 may also have a state which allows the device to remain powered, but not reflect signals. Tag 125 may be a UE 115, or included as part of a UE 115.

BS 105d may assist reader 115r in reducing interference associated with tag 125. In some aspects, BS 105d transmits a command requesting an interference report from reader 115r. While either BS 105d or another UE 115 transmits a reference signal, reader 115r may configure tag 125 to switch between reflective and non-reflective states. By measuring received signal strength at reader 115r during each state, reader 115r and/or BS 105d may determine what portion of the interference is direct, as compared to a signal reflected from tag 125. Reader 115r may transmit the requested interference report based on the measurements to BS 105d. BS 105d may configure reader 115r and/or an aggressor UE 115 (e.g., UE 115c) based on the interference report in order to mitigate excessive interference. For example, based on the interference report, BS 105d may schedule communications such that an aggressor UE 115 does not transmit while tag 125 is in a reflective state. In another example, BS 105d transmits a message to reader 115r indicating that reader 115r should put tag 125 into a non-reflective state at certain times.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-action-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some aspects, the subcarrier spacing between adjacent subcarriers may be fixed, and the total number of subcarriers (K) may be dependent on the system BW. The system BW may also be partitioned into subbands. In other aspects, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes an UL subframe in an UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate an UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. an UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some aspects, the BSs 105 may broadcast the PSS, the SSS, and/or the MIB in the form of synchronization signal block (SSBs) and may broadcast the RMSI and/or the OSI over a physical downlink shared channel (PDSCH). The MIB may be transmitted over a physical broadcast channel (PBCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, an UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit an UL communication signal to the BS 105 via a PUSCH and/or PUCCH according to an UL scheduling grant. The connection may be referred to as an RRC connection. When the UE 115 is actively exchanging data with the BS 105, the UE 115 is in an RRC connected state.

In an example, after establishing a connection with the BS 105, the UE 115 may initiate an initial network attachment procedure with the network 100. The BS 105 may coordinate with various network entities or fifth generation core (5GC) entities, such as an access and mobility function (AMF), a serving gateway (SGW), and/or a packet data network gateway (PGW), to complete the network attachment procedure. For example, the BS 105 may coordinate with the network entities in the 5GC to identify the UE, authenticate the UE, and/or authorize the UE for sending and/or receiving data in the network 100. In addition, the AMF may assign the UE with a group of tracking areas (TAs). Once the network attach procedure succeeds, a context is established for the UE 115 in the AMF. After a successful attach to the network, the UE 115 can move around the current TA. For tracking area update (TAU), the BS 105 may request the UE 115 to update the network 100 with the UE 115's location periodically. Alternatively, the UE 115 may only report the UE 115's location to the network 100 when entering a new TA. The TAU allows the network 100 to quickly locate the UE 115 and page the UE 115 upon receiving an incoming data packet or call for the UE 115.

In some aspects, the BS 105 may communicate with a UE 115 using HARQ techniques to improve communication reliability, for example, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may operate over a shared channel, which may include shared frequency bands and/or unlicensed frequency bands. For example, the network 100 may be an NR-U network operating over an unlicensed frequency band. In such an aspect, the BSs 105 and the UEs 115 may be operated by multiple network operating entities. To avoid collisions, the BSs 105 and the UEs 115 may employ a listen-before-talk (LBT) procedure to monitor for transmission opportunities (TXOPs) in the shared channel. A TXOP may also be referred to as COT. The goal of LBT is to protect reception at a receiver from interference. For example, a transmitting node (e.g., a BS 105 or a UE 115) may perform an LBT prior to transmitting in the channel. When the LBT passes, the transmitting node may proceed with the transmission. When the LBT fails, the transmitting node may refrain from transmitting in the channel.

An LBT can be based on energy detection (ED) or signal detection. For an energy detection-based LBT, the LBT results in a pass when signal energy measured from the channel is below a threshold. Conversely, the LBT results in a failure when signal energy measured from the channel exceeds the threshold. For a signal detection-based LBT, the LBT results in a pass when a channel reservation signal (e.g., a predetermined preamble signal) is not detected in the channel. Additionally, an LBT may be in a variety of modes. An LBT mode may be, for example, a category 4 (CAT4) LBT, a category 2 (CAT2) LBT, or a category 1 (CAT1) LBT. A CAT1 LBT is referred to a no LBT mode, where no LBT is to be performed prior to a transmission. A CAT2 LBT refers to an LBT without a random backoff period. For instance, a transmitting node may determine a channel measurement in a time interval and determine whether the channel is available or not based on a comparison of the channel measurement against a ED threshold. A CAT4 LBT refers to an LBT with a random backoff and a variable contention window (CW). For instance, a transmitting node may draw a random number and backoff for a duration based on the drawn random number in a certain time unit.

Deployment of communication systems, such as 5G new radio (NR) systems, may be arranged in multiple manners with various components or constituent parts. In a 5G NR system, or network, a network node, a network entity, a network unit, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS 105 (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

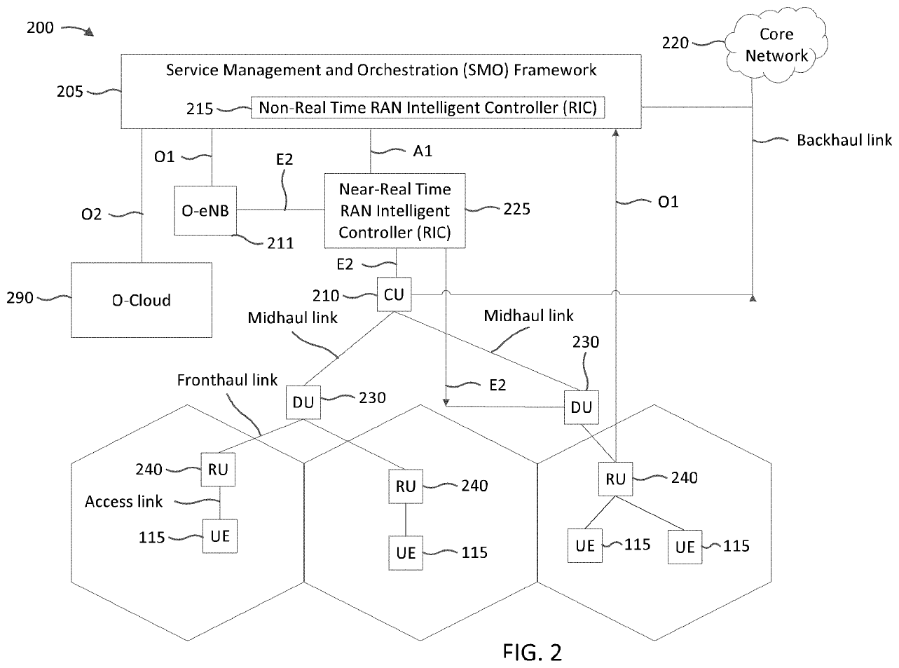

FIG. 2 shows a diagram illustrating an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 115 via one or more radio frequency (RF) access links. In some implementations, the UE 115 may be simultaneously served by multiple RUs 240.

Each of the units, i.e., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 115. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

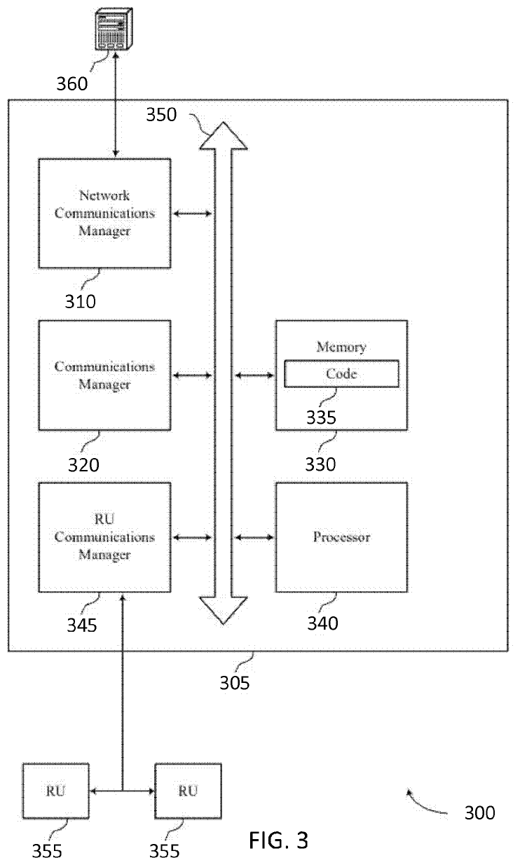

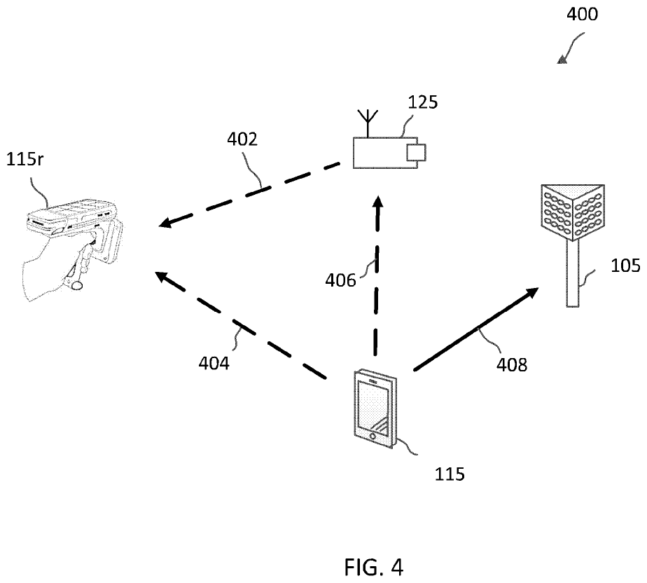

FIG. 3 shows a diagram of a system 300 including a device 305 that supports RU sharing techniques in wireless communications in accordance with aspects of the present disclosure. The device 305 may communicate with one or more RUs 355. The device 305 may include components for bi-directional voice and data communications including components for transmitting and receiving communications, such as a communications manager 320, a network communications manager 310, a memory 330, code 335, a processor 340, and a RU communications manager 345. These components may be in electronic communication or otherwise coupled (e.g., operatively, communicatively, functionally, electronically, electrically) via one or more buses (e.g., a bus 350). One or more of the components of system 300 may perform functions as described herein with reference to FIGS. 4-11, for example functions described as performed by a base station or network unit.

The network communications manager 310 may manage communications with a core network 360 (e.g., via one or more wired backhaul links). For example, the network communications manager 310 may manage the transfer of data communications for client devices, such as one or more UEs 115.

The memory 330 may include RAM and ROM. The memory 330 may store computer-readable, computer-executable code 335 including instructions that, when executed by the processor 340, cause the device 305 to perform various functions described herein. The code 335 may be stored in a non-transitory computer-readable medium such as system memory or another type of memory. In some cases, the code 335 may not be directly executable by the processor 340 but may cause a computer (e.g., when compiled and executed) to perform functions described herein. In some cases, the memory 330 may contain, among other things, a BIOS which may control basic hardware or software operation such as the interaction with peripheral components or devices.

The processor 340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 340 may be configured to operate a memory array using a memory controller. In some other cases, a memory controller may be integrated into the processor 340. The processor 340 may be configured to execute computer-readable instructions stored in a memory (e.g., the memory 330) to cause the device 305 to perform various functions (e.g., functions or tasks supporting RU sharing techniques in wireless communications). For example, the device 305 or a component of the device 305 may include a processor 340 and memory 330 coupled to the processor 340, the processor 340 and memory 330 configured to perform various functions described herein.

The RU communications manager 345 may manage communications with RUs 355, and may include a controller or scheduler for controlling communications with UEs 115 in cooperation with RUs 355. For example, the RU communications manager 345 may coordinate scheduling for transmissions to UEs 115. In some examples, the RU communications manager 345 may provide an F1 interface within a wireless communications network technology to provide communication with RUs 355.

The communications manager 320 may support wireless communications at a network node in accordance with examples as disclosed herein. For example, the communications manager 320 may be configured as or otherwise support a means for transmitting, to a first RU, a request for a wireless resource configuration for a first time period. The communications manager 320 may be configured as or otherwise support a means for transmitting, to a second RU, an interference inquiry associated with the wireless resource configuration for the first time period. The communications manager 320 may be configured as or otherwise support a means for receiving, from the second RU, a response to the interference inquiry. The communications manager 320 may be configured as or otherwise support a means for transmitting, based on the response to the interference inquiry, a payload to the first RU for transmission during the first time period.

By including or configuring the communications manager 320 in accordance with examples as described herein, the device 305 may support techniques for RU sharing in which DUs of different MNOs may access wireless resources of other MNOs, which may increase efficiency of resource usage while provide for competition and innovation among different MNOs, may increase the reliability of wireless communications, decrease latency, and enhance user experience.

In some examples, the communications manager 320 may be configured to perform various operations (e.g., receiving, monitoring, transmitting) using or otherwise in cooperation with other components. Although the communications manager 320 is illustrated as a separate component, in some examples, one or more functions described with reference to the communications manager 320 may be supported by or performed by the processor 340, the memory 330, the code 335, or any combination thereof. For example, the code 335 may include instructions executable by the processor 340 to cause the device 305 to perform various aspects of RU sharing techniques in wireless communications as described herein, or the processor 340 and the memory 330 may be otherwise configured to perform or support such operations.

FIG. 4 illustrates an example wireless communication network 400 according to some aspects of the present disclosure. Network 400 includes a BS 105, which may be a BS 105 as described with respect to FIG. 1, a network unit 800, or one or more components of a disaggregated base station 200 (e.g., CU 210, DU 230, and/or RU 240) discussed with reference to FIGS. 2-3. Network 400 includes a tag 125 in communication with a reader 115r. The arrows between devices in FIG. 4 represent signals, where solid lines represent intentional signals and dashed lines represent unintentional interference either direct or reflected (also referred to as indirect).

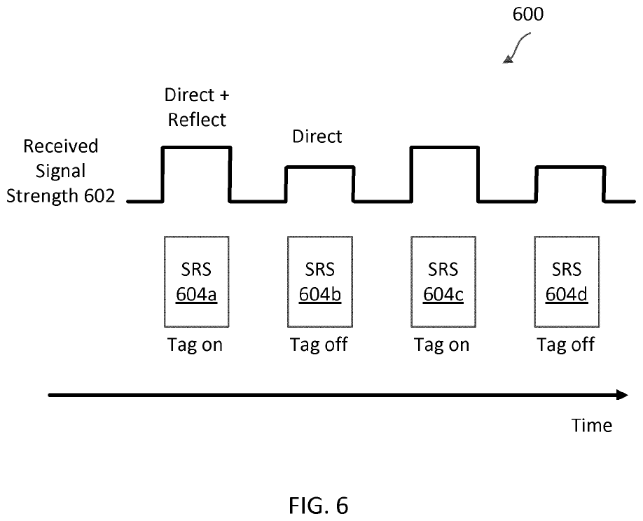

The communications illustrated in FIG. 4 represent a scenario in which a wireless communication device such as a BS 105 and/or reader 115r may perform methods as described herein with reference to FIGS. 6-11 in order to mitigate interference. Specifically, in this example, UE 115 is transmitting signal 408 to BS 105. Since signal 408 is not perfectly directional, there is some signal power which radiates in other directions which may cause interference. For example, signal 404 is an interfering signal which is a part of signal 408 which propagates directly between UE 115 and reader 115r. Signal 402 is a reflection from tag 125 of signal 406 from UE 115 which is a part of signal 408. In the illustrated scenario, reader 115r may have previously been unable to determine how much of the received interference signal is due to direct interference (e.g., signal 404) compared to reflected interference (e.g., signal 402). As described further herein with reference to FIGS. 6-11, reader 115r in connection with other devices may disaggregate the interference so that devices in network 400 may make decisions based on that determined information in order to mitigate excess cross link interference.

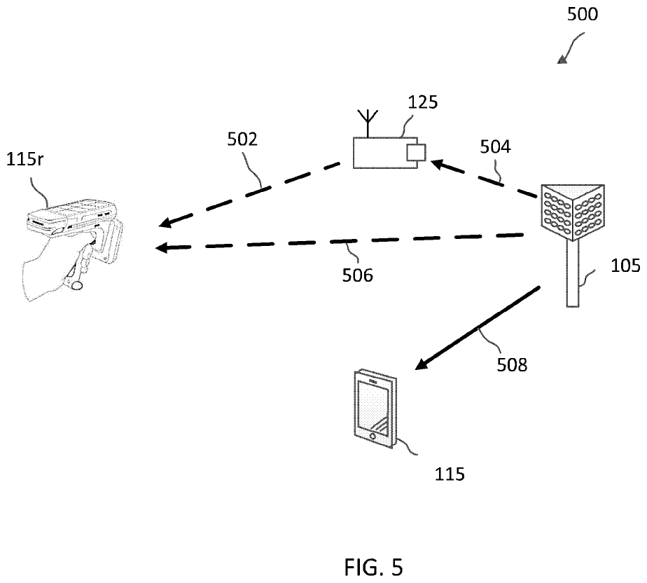

FIG. 5 illustrates an example wireless communication network 400 according to some aspects of the present disclosure. Network 500 is similar to network 400 in that it contains a reader 115r, tag 125, a BS 105, and a UE 115. However, in network 500 as illustrated, UE 115 is receiving a downlink signal 508 rather than transmitting. As in FIG. 4, the arrows between devices in FIG. 5 represent signals, where solid lines represent intentional signals and dashed lines represent unintentional interference either direct or reflected.

The communications illustrated in FIG. 5 represent a scenario in which a wireless communication device such as a BS 105 and/or reader 115r may perform methods as described herein with reference to FIGS. 6-11 in order to mitigate interference. Specifically, in this example, BS 105 is transmitting signal 508 to UE 115. Since signal 508 is not perfectly directional, there is some signal power which radiates in other directions which may cause interference. Signal 506 is the portion of signal 508 which unintentionally propagates directly between BS 105 and reader 115r. Signal 502 is a reflection from tag 125 of signal 504 from BS 105 which is a portion of signal 508 propagating towards tag 125. In the illustrated scenario, reader 115r may previously have been unable to determine how much of the received interference signal is due to direct interference (e.g., signal 506) compared to reflected interference (e.g., signal 502). As described further herein with reference to FIGS. 6-11, reader 115r in connection with other devices may disaggregate the interference so that devices in network 500 may make decisions based on that determined information in order to mitigate excess cross link interference.

As illustrated in FIGS. 4 and 5, tag 125 communicates by backscatter communication, instead of using an active transmitter. The nature of this communication can be harnessed in order to implement aspects of the present disclosure, so as to enable the reader 115r, BS 105, or both to disaggregate interference between direct interference from an aggressor UE 115 as in FIG. 4 or from a BS 105 as in FIG. 5, and indirect interference (reflected interference from the passive RF device 115r in both FIGS. 4 and 5). An exemplary process of determining direct and indirect interference is illustrated in FIG. 6.

FIG. 6 illustrates an example sequence diagram 600 of received signal strength over time with alternating passive RF device states according to some aspects of the present disclosure. The horizontal axis represents time in some units. The waveform represents received signal strength 602, which is a measurement of received power by a reader 115r according to some aspects described herein.

For example, a reader 115r may measure the received power 602 at different times over the illustrated sequence in order to determine the received power level when a tag 125 is “on” (i.e., in a reflective state), and “off” (i.e., in a non-reflective state). SRS 604 may be a continuous SRS signal from a device such as a BS 105 or a UE 115, or may be individual SRS signals as illustrated (SRSs 604a, 604b, 604c, and 604d). As discussed with reference to FIGS. 4-5, a tag 125 may reflect signals intended for other sources, which may increase the amount of interference seen by a reader 115r. In some aspects, tag 125 is configured to turn on and off (or more generally toggle between reflective and non-reflective states) so that reader 115 may measure received signal strength under those conditions. The signal strength measurements associated with different states of tag 125 allow reader 115r or BS 105 to determine how much interference is caused due to what source (e.g., direct vs. indirect).

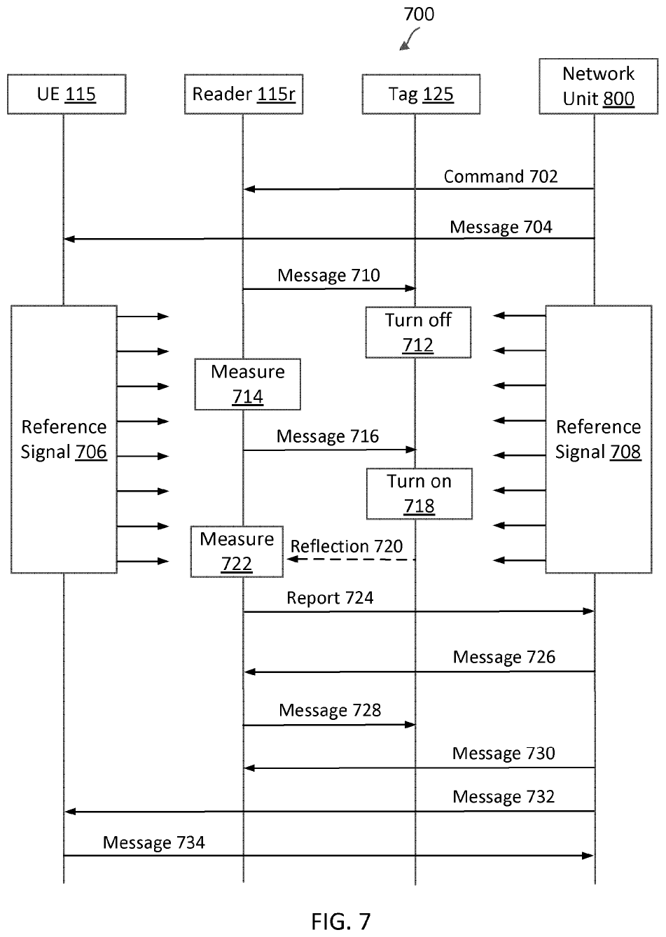

At times in the sequence 600 when the tag 125 is on, such as during SRS 604a and SRS 604c, the measured received power 602 represents the combination of direct and reflected interference. At times in the sequence 600 when the tag 125 is off, such as during SRS 604b and SRS 604d, the measured received power 602 represents only the direct interference, as there is no significant reflection from tag 125. By comparing the measurements taken while the tag is in a reflective state to the measurements taken while the tag is in a non-reflective state, the reader 115r or BS 105 may determine the amount of interference which is contributed by the reflected signal. As discussed further with respect to FIGS. 7-11, this information may be used to mitigate excess cross link interference.

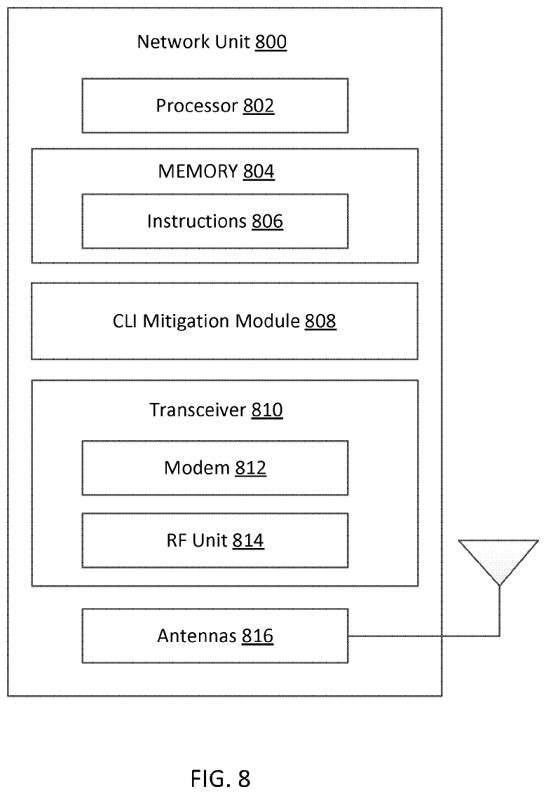

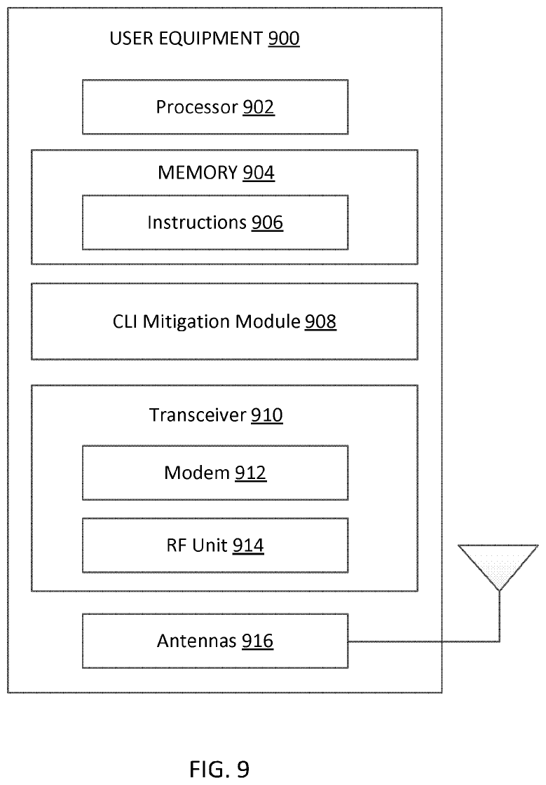

FIG. 7 is a signaling diagram 700 according to some aspects of the present disclosure. The diagram 700 is employed by a network unit 800 such as the BS 105, discussed with reference to FIG. 1, one or more components of disaggregated base station 200 (e.g., CU 210, DU 230, and/or RU 240) discussed with reference to FIGS. 2-3. Network unit 800 may utilize one or more components, such as the processor 802, the memory 804, the CLI mitigation module 808, the transceiver 810, the modem 812, and the one or more antennas 816 shown in FIG. 8, and the UE 115 may utilize one or more components, such as the processor 902, the memory 904, the CLI mitigation module 908, the transceiver 910, the modem 912, and the one or more antennas 916 shown in FIG. 9. Signaling diagram 700 also includes a reader 115r and tag 125 as described with reference to FIG. 1. As illustrated, the signaling diagram 700 includes a number of enumerated actions, but aspects of FIG. 7 may include additional actions before, after, and in between the enumerated actions. In some aspects, one or more of the enumerated actions may be omitted, combined together, or performed in a different order.

At action 702, network unit 800 transmits a command to reader 115r a command to provide an interference report. The network unit 800 may transmit the command in response to a request from the reader 115r, or a determination based on network characteristics. The request may be transmitted, for example via a PDCCH in a DCI message, or via RRC.

At action 704, the network unit 800 transmits a message scheduling UE 115 to transmit a reference signal (e.g., SRS). The reference signal transmission may be scheduled for when the reader 115r will be making interference measurements, so that the reader 115r may measure the level of interference when the network unit 800 and/or UE 115 is transmitting.

At action 706, UE 115 transmits a reference signal (e.g., SRS). The reference signal may be directed to device such as network unit 800 (for example, as illustrated by signal 408 in FIG. 4). However, the reference signal may be transmitted so that reader 115r may measure the reflected and direct received signal strength. The reference signal transmitted by UE 115 may be a single waveform that continues for the duration of the measuring sequence, or may be comprised of individual reference signals that are transmitted during windows in which reader 115r is measuring.

At action 708, network unit 800 transmits a reference signal (e.g., CSI-RS). The reference signal may be directed to device such as UE 115 (for example, as illustrated by signal 508 in FIG. 5). However, the reference signal may be transmitted so that reader 115r may measure the reflected and direct received signal strength. The reference signal transmitted by network unit 800 may be a single waveform that continues for the duration of the measuring sequence, or may be comprised of individual reference signals that are transmitted during windows in which reader 115r is measuring.

At action 710, reader 115r transmits, to a tag 125, a message to enter a non-reflective state. The message may be transmitted in response to the interference report request. In this example, the message puts the passive RF device into a non-reflective state, however the order of reflective and non-reflective states may be different. The message may indicate that the tag 125 enter a mode in which the device powers down, or may indicate only to enter a mode in which reflections are substantially eliminated. The message may also configure tag 125 to perform a sequence of switching between reflective and non-reflective states without subsequent messages.

At action 712, tag 125 turns off, or enters an otherwise non-reflective mode of operation, in response to the message from reader 115r transmitted at action 710. Note that no substantial reflection is shown from tag 125 while in the non-reflective state. In this way, any signal received by reader 115r during this time does not include a contribution from a reflection by tag 125.

At action 714, reader 115r measures received signal strength. For example it may perform a received signal strength indicator (RSSI) measurement. Since no significant reflection is produced by tag 125 while it is in a non-reflective state, any received signal does not include a reflection from tag 125. The measurement instead will reflect the strength of the reference signal from UE 115 described at action 706 and/or the reference signal from network unit 800 described at action 708. This establishes a baseline “direct” interference level which may be used to compare later with a measurement which includes reflections.

At action 716, reader 115r transmits, to a tag 125, a message to enter a reflective state. The message may be transmitted in response to the interference report request. In this example, the message puts the passive RF device into a reflective state, however the order of reflective and non-reflective states may be different. The message may indicate that the tag 125 enter a mode in which the device powers on, or may indicate only to enter a mode in which tag 125 is reflective.

At action 718, tag 125 turns on, or enters an otherwise reflective mode of operation, in response to the message from reader 115r transmitted at action 716.

At action 720, tag 125 reflects signals which may be received by reader 115r. For example, a reference signal from UE 115 as described at action 706, and/or a reference signal from network unit 800 as described at action 708.

At action 722, reader 115r measures received signal strength. For example it may perform a received signal strength indicator (RSSI) measurement. Since there may be a reflection produced by tag 125 while it is in a reflective state, any received signal may include a reflection from tag 125. For example, the measurement may include “direct” signals from UE 115 and/or network unit 800 as described at action 714, and additionally include reflected versions of those signals as reflected by tag 125. This receives signal strength measurement may be compared to the baseline measurement at action 714 in order to establish the amount of signal strength that is contributed by reflections from tag 125. For example, but finding the difference between the two values.

At action 724, reader 115r transmits the interference report to network unit 800 based on the first interference measurement described at action 714 and the second interference measurement described at action 722. The interference report may be based on additional measurements if the sequence is repeated more than once. In some aspects, reader 115r calculates a reflected interference value based on a difference between the first interference measurement and the second interference measurement, and the reflected interference value is included in the interference report. The direct interference value may also be included in the report. In other aspects, the interference report contains only the measurement values, allowing for network unit 800 to make the determination. The interference report may be transmitted, for example, via PUSCH or PUCCH, to the wireless communications device (e.g., BS 105, network unit 800, CU 210, DU 230, and/or RU 240).

At action 726, network unit 800 transmits, to reader 115r, a message based on the interference report. In some aspects, the message may comprise a scheduled time for reader 115r to communicate with tag 125. For example, based on a determination by network unit 800 that interference is above a predetermined threshold when tag 125 is in a reflective mode. The predetermined threshold may be preconfigured, or dynamically configured by network unit 800. Reader 125 may be scheduled to communicate with tag 125 when UE 115 and/or network unit 800 is not scheduled to transmit based on the message. In this way, excessive interference may be avoided.

In other aspects, the message at action 726 from network unit 800 may comprise an indication to reader 115r to configure tag 125 for a non-reflective state at a scheduled time to reduce interference received by reader 115r. For example, the message may have reader 115r put tag 125 into a non-reflective state when network unit 800 is scheduled to transmit a downlink message to reader 115r, or when UE 115 is transmitting and would potentially cause excessive interference.

At action 728, reader 115r communicates with tag 125 based on the message described at action 726. For example, reader 115r transmits and receives a response from tag 125 at the time scheduled by the message. In another example, reader 115r turns tag 125 off or into another non-reflective state at a time determined by the message described at action 726.

At action 730, reader 115r communicates with network unit 800 based on the message described at action 726. For example, reader 115r receives a downlink message from network unit 800 at the time scheduled by the message described at action 726. In another example, reader 115r turns tag 125 off or into another non-reflective state at a time determined by the message described at action 726 so that it receives the downlink message from network unit 800 while tag 125 is in a non-reflective state.

At action 732, network unit 800 transmits, to UE 115, a message based on the interference report. The message may identify a scheduled time for UE 115 to communicate with network unit 800. For example, UE 115 may be scheduled to communicate with network unit 800 when reader 115r is not scheduled to communicate with tag 125. The scheduling may be based on a determination that UE 115 is causing interference above a predetermined threshold when tag 125 is in a reflective state.

At action 734, UE 115 communicates with network unit 800 based on the message described at action 726. For example, UE 115 transmits an uplink message to network unit 800 at the time scheduled by the message described at action 732.

FIG. 8 is a block diagram of an exemplary network unit 800 according to some aspects of the present disclosure. The network unit 800 may be a BS 105 as discussed in FIGS. 1 and 4-7, or be made up of disaggregated units as described with reference to FIGS. 2-3. As shown, the network unit 800 may include a processor 802, a memory 804, an CLI mitigation module 808, a transceiver 810 including a modem subsystem 812 and a RF unit 814, and one or more antennas 816. These elements may be coupled with one another. The term “coupled” may refer to directly or indirectly coupled or connected to one or more intervening elements. For instance, these elements may be in direct or indirect communication with each other, for example via one or more buses.

The processor 802 may have various features as a specific-type processor. For example, these may include a CPU, a DSP, an ASIC, a controller, a FPGA device, another hardware device, a firmware device, or any combination thereof configured to perform the operations described herein. The processor 802 may also be implemented as a combination of computing devices, e.g., a combination of a DSP and a microprocessor, a plurality of microprocessors, one or more microprocessors in conjunction with a DSP core, or any other such configuration.

The memory 804 may include a cache memory (e.g., a cache memory of the processor 802), RAM, MRAM, ROM, PROM, EPROM, EEPROM, flash memory, a solid-state memory device, one or more hard disk drives, memristor-based arrays, other forms of volatile and non-volatile memory, or a combination of different types of memory. In some aspects, the memory 804 may include a non-transitory computer-readable medium. The memory 804 may store instructions 806. The instructions 806 may include instructions that, when executed by the processor 802, cause the processor 802 to perform operations described herein, for example, aspects of FIGS. 1-11. Instructions 806 may also be referred to as program code. The program code may be for causing a wireless communication device to perform these operations, for example by causing one or more processors (such as processor 802) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The CLI mitigation module 808 may be implemented via hardware, software, or combinations thereof. For example, the CLI mitigation module 808 may be implemented as a processor, circuit, and/or instructions 806 stored in the memory 804 and executed by the processor 802. In some examples, the CLI mitigation module 808 can be integrated within the modem subsystem 812. For example, the CLI mitigation module 808 can be implemented by a combination of software components (e.g., executed by a DSP or a general processor) and hardware components (e.g., logic gates and circuitry) within the modem subsystem 812. The CLI mitigation module 808 may communicate with one or more components of network unit 800 to implement various aspects of the present disclosure, for example, aspects of FIGS. 1-11.

In some aspects, the CLI mitigation module 808 may be configured to receive, from a UE, a rank indicator (RI). The RI may be received as part of channel state feedback information. The channel state feedback may be received, for example, via an RRC message, UL MAC CE, channel state information (CSI) message, a synchronization signal block (SSB), or other suitable communication, using PUCCH, PSCCH, or another suitable channel. The channel state feedback information may include a precoding matrix indicator (PMI) and/or a channel quality indicator (CQI) corresponding to the RI. The RI may define the number of possible transmission layers for the downlink transmission under specific channel conditions. The RI may correspond to a maximum number of uncorrelated paths that can be used for downlink transmission. The RI, however, may not contain information directly related to the number of antenna panels or modules used by the UE in achieving the indicated RI.

The CLI mitigation module 808 may be configured to control a sequence which allows a UE to measure signals in order to determine an estimate of how much interference is received by the UE under different conditions. Specifically, while a passive RF device (e.g., tag 125) is in a reflective or non-reflective state (whether by powering on and off or otherwise). The CLI mitigation module 808 achieves this by first transmitting, to a first UE (e.g., reader 115r, UE 115, UE 900, or other UE), a command to provide an interference report. The CLI mitigation module 808 may transmit the command in response to a request from the UE, or a determination based on network characteristics. The request may be transmitted, for example via a PDCCH in a DCI message, or via RRC.

CLI mitigation module 808 may be configured to schedule to transmit a reference signal (e.g., CSI-RS) for the first UE to measure and/or transmit, to a second UE, a first message scheduling the second UE to transmit a reference signal (e.g., SRS). The reference signal transmission may be scheduled for when the first UE will be making interference measurements, so that the UE may measure the level of interference when the network unit and/or another UE 115 is transmitting.

CLI mitigation module 808 may be configured to transmit the reference signal if scheduled. The reference signal may be a CSI-RS. It may be a single reference signal, or a series of reference signals which are transmitted at times when the UE is scheduled to make interference measurements.

CLI mitigation module 808 may be configured to receive, from the first UE, the interference report. The interference report may be based on interference measurements (e.g., RSSI measurements) performed by the UE, where each measurement is performed while a passive RF device is in a reflective or non-reflective state as discussed with reference to FIG. 6. In some aspects, the interference report contains a reflected interference value calculated by the UE based on the interference measurements. The interference report may also include the direct interference value. In other aspects, the measurement values are included in the interference report. The CLI mitigation module 808 may determine a reflected interference value based on the measurements received in the interference report. The interference report may be received, for example, via PUSCH or PUCCH from the first UE.

CLI mitigation module 808 may be configured to transmit, to the first UE, a second message based on the interference report. In some aspects, the second message may comprise a scheduled time for the UE to communicate with the passive RF device. For example, based on a determination by the CLI mitigation module 808 that interference is above a predetermined threshold when the passive RF device is in a reflective mode. The predetermined threshold may be preconfigured, or dynamically configured by the network unit. The first UE may be scheduled to communicate with the passive RF device when the aggressor device is not scheduled to transmit based on the second message. In this way, excessive interference may be avoided.

CLI mitigation module 808 may be configured to transmit, to the second UE, a third message based on the interference report. The third message may identify a scheduled time for the second UE to communicate with the network unit. For example, the second UE may be scheduled to communicate with the network unit when the first UE is not scheduled to communicate with the passive RF device. The scheduling may be based on a determination that the second UE is causing interference above a predetermined threshold when the passive RF device is in a reflective state.

CLI mitigation module 808 may be configured to communicate with the first UE based on the second message and the third message. For example, the network unit 800 may communicate with the first UE at a time when the network unit indicated to the first UE to put the passive RF device in a non-reflective state (either powered off, or non-reflecting in some other way), so that the signal from the network unit may be received by the first UE without excessive interference.

As shown, the transceiver 810 may include the modem subsystem 812 and the RF unit 814. The transceiver 810 can be configured to communicate bi-directionally with other devices, such as the UEs 115 and/or BS 105 and/or another core network element. The modem subsystem 812 may be configured to modulate and/or encode data according to a MCS, e.g., a LDPC coding scheme, a turbo coding scheme, a convolutional coding scheme, a digital beamforming scheme, etc. The RF unit 814 may be configured to process (e.g., perform analog to digital conversion or digital to analog conversion, etc.) modulated/encoded data (e.g., PDCCH DCI, MAC-CE, PSSCH, etc.) from the modem subsystem 812 (on outbound transmissions) or of transmissions originating from another source such as a UE 115, and/or UE 900. The RF unit 814 may be further configured to perform analog beamforming in conjunction with the digital beamforming. Although shown as integrated together in transceiver 810, the modem subsystem 812 and/or the RF unit 814 may be separate devices that are coupled together at the network unit 800 to enable the network unit 800 to communicate with other devices.

The RF unit 814 may provide the modulated and/or processed data, e.g. data packets (or, more generally, data messages that may contain one or more data packets and other information), to the antennas 816 for transmission to one or more other devices. The antennas 816 may further receive data messages transmitted from other devices and provide the received data messages for processing and/or demodulation at the transceiver 810. The transceiver 810 may provide the demodulated and decoded data (e.g., PUSCH, PSSCH, etc.) to the CLI mitigation module 808 for processing. The antennas 816 may include multiple antennas of similar or different designs in order to sustain multiple transmission links.

In an aspect, the network unit 800 can include multiple transceivers 810 implementing different RATs (e.g., NR and LTE). In an aspect, the network unit 800 can include a single transceiver 810 implementing multiple RATs (e.g., NR and LTE). In an aspect, the transceiver 810 can include various components, where different combinations of components can implement different RATs.

FIG. 9 is a block diagram of an exemplary UE 900 according to some aspects of the present disclosure. The UE 900 may be a UE 115 as discussed in FIGS. 1-7. As shown, the UE 900 may include a processor 902, a memory 904, an CLI mitigation module 908, a transceiver 910 including a modem subsystem 912 and a radio frequency (RF) unit 914, and one or more antennas 916. These elements may be coupled with one another. The term “coupled” may refer to directly or indirectly coupled or connected to one or more intervening elements. For instance, these elements may be in direct or indirect communication with each other, for example via one or more buses.

The processor 902 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 902 may also be implemented as a combination of computing devices, e.g., a combination of a DSP and a microprocessor, a plurality of microprocessors, one or more microprocessors in conjunction with a DSP core, or any other such configuration.

The memory 904 may include a cache memory (e.g., a cache memory of the processor 902), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 904 includes a non-transitory computer-readable medium. The memory 904 may store, or have recorded thereon, instructions 906. The instructions 906 may include instructions that, when executed by the processor 902, cause the processor 902 to perform the operations described herein with reference to a UE 115 in connection with aspects of the present disclosure, for example, aspects of FIGS. 1-7 and 10-11. Instructions 906 may also be referred to as code, which may be interpreted broadly to include any type of computer-readable statement(s).

The CLI mitigation module 908 may be implemented via hardware, software, or combinations thereof. For example, the CLI mitigation module 908 may be implemented as a processor, circuit, and/or instructions 906 stored in the memory 904 and executed by the processor 902. In some aspects, the CLI mitigation module 908 can be integrated within the modem subsystem 912. For example, the CLI mitigation module 908 can be implemented by a combination of software components (e.g., executed by a DSP or a general processor) and hardware components (e.g., logic gates and circuitry) within the modem subsystem 912. The CLI mitigation module 908 may communicate with one or more components of UE 900 to implement various aspects of the present disclosure, for example, aspects of FIGS. 1-7 and 10-11

In some aspects, CLI mitigation module 908 may be configured to receive, from a first wireless communication device (e.g., BS 105, network unit 800, CU 210, DU 230, and/or RU 240), a command to provide an interference report. The first wireless communication device may transmit the command in response to a request from the UE, or a determination based on network characteristics. The command may be received, for example via a PDCCH in a DCI message, or via RRC.

CLI mitigation module 908 may be configured to transmit, to a passive radio frequency (RF) device (e.g., a tag 125), a first message to enter a non-reflective state. The first message may be transmitted in response to the interference report request. In this example, the first message puts the passive RF device into a non-reflective state, however the order of reflective and non-reflective states may be different. The first message may indicate that the passive RF device enter a mode in which the device powers down, or may indicate only to enter a mode in which reflections are substantially eliminated. The first message may also configure the passive RF device to perform a sequence of switching between reflective and non-reflective without subsequent messages.

CLI mitigation module 908 may be configured to perform a first interference measurement while the passive RF device is in the non-reflective state (either powered off, or non-reflecting in some other way). As the passive RF device is in a non-reflective state, any received signal will represent direct interference, or interference reflected off an object other than the passive RF device. Measured signals may include signals from an aggressor UE 115 which is transmitting a signal to another device such as a BS 105. Measured signals may also include signals from a network unit such as a BS 105 which is transmitting a signal to another UE 115. The signals may be reference signals (e.g., SRS or CSI-RS) which are transmitted for the purpose of the UE making interference measurements. The first interference measurement may be, for example, a received signal strength indicator (RSSI) measurement. The first interference measurement may establish a baseline with which to compare other measurements.

CLI mitigation module 908 may be configured to transmit, to the passive RF device, a second message to enter a reflective state. The second message may be a command to power on the passive RF device, and/or to enter a reflective mode. This reflective mode may be a different mode than when the passive RF device is communicating, as the reflectivity may remain on rather than changing on and off in a patterned sequence. In some aspects, the first message configured the passive RF device with a toggling pattern, so that an individual message is not needed for each transition between reflective and non-reflective states.

CLI mitigation module 908 may be configured to perform a second interference measurement while the passive RF device is in the reflective state. The second interference measurement may include received signal from the same sources as the first interference measurement, in addition to any reflected signal from the passive RF device. The second interference measurement may be, for example, a received signal strength indicator (RSSI) measurement.

The first and second measurements may each comprise of multiple individual measurements which are combined in some way (e.g., averaged). Further, the pattern of toggling the state of the passive RF device and measuring the received signal in each state may be repeated some number of times, for example as illustrated in FIG. 6.

CLI mitigation module 908 may be configured to transmit the interference report to the wireless communication device based on the first interference measurement and the second interference measurement. The interference report may be based on additional measurements if the sequence is repeated more than once. In some aspects, the CLI mitigation module 908 calculates a reflected interference value based on a difference between the first interference measurement and the second interference measurement, and the reflected interference value is included in the interference report. The direct interference value may also be included in the report. In other aspects, the interference report contains only the measurement values. The interference report may be transmitted, for example, via PUSCH or PUCCH, to the wireless communications device (e.g., BS 105, network unit 800, CU 210, DU 230, and/or RU 240).

CLI mitigation module 908 may be configured to receive a third message from the wireless communication device based on the interference report. In some aspects, the third message may comprise a scheduled time for the UE 900 to communicate with the passive RF device. For example, based on a determination that interference is above a predetermined threshold when the passive RF device is in a reflective mode. The predetermined threshold may be preconfigured, or dynamically configured by the network unit. The UE 900 may be scheduled by the third message to communicate with the passive RF device when the aggressor device is not scheduled to transmit. In this way, excessive interference may be avoided.

In other aspects, the third message may comprise an indication to the CLI mitigation module 908 of UE 900 to configure the passive RF device for a non-reflective state at a scheduled time to reduce interference received by the wireless communication device. For example, the third message may have the UE 900 put the passive RF device into a non-reflective state when a BS 105 is scheduled to transmit a downlink message to the UE 900, or when another aggressor device such as another UE 115 is transmitting and would potentially cause excessive interference.

CLI mitigation module 908 may be configured to communicate with the passive RF device based on the third message. For example, the CLI mitigation module 908 may transmit and receive a response from the passive RF device at the time scheduled by the third message. In another example, the CLI mitigation module 908 may be configured to turn the passive RF device off or into another non-reflective state at a time determined by the third message.

As shown, the transceiver 910 may include the modem subsystem 912 and the RF unit 914. The transceiver 910 can be configured to communicate bi-directionally with other devices, such as the BSs 105 and 500. The modem subsystem 912 may be configured to modulate and/or encode the data from the memory 904 and/or the CLI mitigation module 908 according to a modulation and coding scheme (MCS), e.g., a low-density parity check (LDPC) coding scheme, a turbo coding scheme, a convolutional coding scheme, a digital beamforming scheme, etc. The RF unit 914 may be configured to process (e.g., perform analog to digital conversion or digital to analog conversion, etc.) modulated/encoded data (e.g., PUSCH, PSSCH, etc.) or of transmissions originating from another source such as a UE 115, or a BS 105. The RF unit 914 may be further configured to perform analog beamforming in conjunction with the digital beamforming. Although shown as integrated together in transceiver 910, the modem subsystem 912 and the RF unit 914 may be separate devices that are coupled together at the UE 900 to enable the UE 900 to communicate with other devices.

The RF unit 914 may provide the modulated and/or processed data, e.g., data packets (or, more generally, data messages that may contain one or more data packets and other information), to the antennas 916 for transmission to one or more other devices. The antennas 916 may further receive data messages transmitted from other devices. The antennas 916 may provide the received data messages for processing and/or demodulation at the transceiver 910. The transceiver 910 may provide the demodulated and decoded data (e.g., PDCCH DCI, MAC-CE, PSSCH, etc.) to the CLI mitigation module 908 for processing. The antennas 916 may include multiple antennas of similar or different designs in order to sustain multiple transmission links. Antennas 916 may include multiple antenna modules, each associated with a different antenna panel. Antenna panels may be used to transmit and/or receive using beamforming techniques.

In an aspect, the UE 900 can include multiple transceivers 910 implementing different RATs (e.g., NR and LTE). In an aspect, the UE 900 can include a single transceiver 910 implementing multiple RATs (e.g., NR and LTE). In an aspect, the transceiver 910 can include various components, where different combinations of components can implement different RATs.

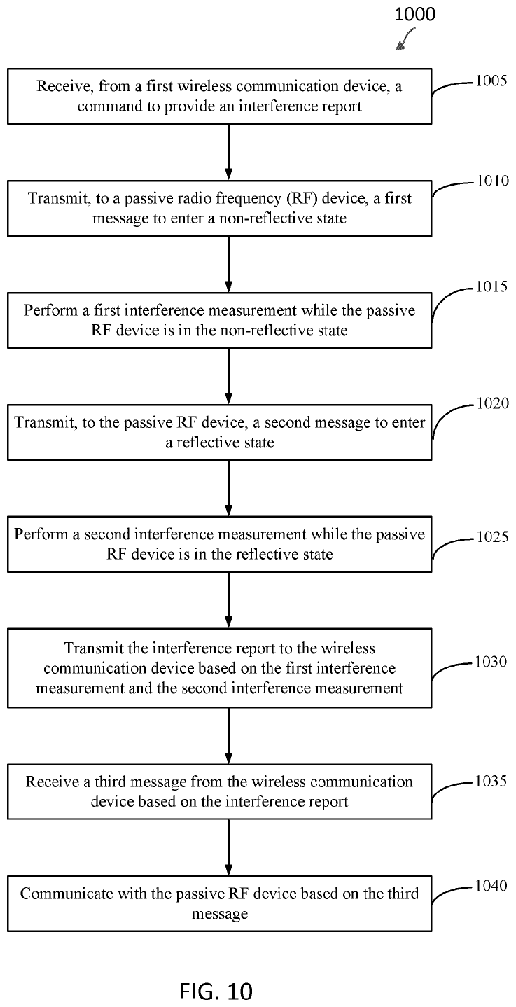

FIG. 10 is a flow diagram illustrating a wireless communication method 1000 according to some aspects of the present disclosure. Aspects of the method 1000 can be executed by a computing device (e.g., a processor, processing circuit, and/or other suitable component) of a wireless communication device or other suitable means for performing the blocks. In one aspect, a reader 115r, UE 115, or 900, may perform the method 1000 utilizing components such as the processor 902, the memory 904, the CLI mitigation module 908, the transceiver 910, the modem 912, and the one or more antennas 916 shown in FIG. 9. As illustrated, the method 1000 includes a number of enumerated blocks, but aspects of the method 1000 may include additional blocks before, after, and in between the enumerated blocks. In some aspects, one or more of the enumerated blocks may be omitted or performed in a different order.

At block 1005, a UE (e.g., reader 115r, UE 115, UE 900, or other UE) receives, from a first wireless communication device (e.g., BS 105, network unit 800, CU 210, DU 230, and/or RU 240), a command to provide an interference report. The first wireless communication device may transmit the command in response to a request from the UE, or a determination based on network characteristics. The command may be received, for example via a PDCCH in a DCI message, or via RRC.

At block 1010, the UE transmits, to a passive radio frequency (RF) device (e.g., a tag 125), a first message to enter a non-reflective state. The first message may be transmitted in response to the interference report request. In this example, the first message puts the passive RF device into a non-reflective state, however the order of reflective and non-reflective states may be different. The first message may indicate that the passive RF device enter a mode in which the device powers down, or may indicate only to enter a mode in which reflections are substantially eliminated. The first message may also configure the passive RF device to perform a sequence of switching between reflective and non-reflective without subsequent messages.

At block 1015, the UE performs a first interference measurement while the passive RF device is in the non-reflective state (either powered off, or non-reflecting in some other way). As the passive RF device is in a non-reflective state, any received signal will represent direct interference, or interference reflected off an object other than the passive RF device. Measured signals may include signals from an aggressor UE 115 which is transmitting a signal to another device such as a BS 105. Measured signals may also include signals from a network unit such as a BS 105 which is transmitting a signal to another UE 115. The signals may be reference signals (e.g., SRS or CSI-RS) which are transmitted for the purpose of the UE making interference measurements. The first interference measurement may be, for example, a received signal strength indicator (RSSI) measurement. The first interference measurement may establish a baseline with which to compare other measurements.

At block 1020, the UE transmits, to the passive RF device, a second message to enter a reflective state. The second message may be a command to power on the passive RF device, and/or to enter a reflective mode. This reflective mode may be a different mode than when the passive RF device is communicating, as the reflectivity may remain on rather than changing on and off in a patterned sequence. In some aspects, the first message configured the passive RF device with a toggling pattern, so that an individual message is not needed for each transition between reflective and non-reflective states.

At block 1025, the UE performs a second interference measurement while the passive RF device is in the reflective state. The second interference measurement may include received signal from the same sources as the first interference measurement, in addition to any reflected signal from the passive RF device. The second interference measurement may be, for example, a received signal strength indicator (RSSI) measurement.

The first and second measurements may each comprise of multiple individual measurements which are combined in some way (e.g., averaged). Further, the pattern of toggling the state of the passive RF device and measuring the received signal in each state may be repeated some number of times, for example as illustrated in FIG. 6.

At block 1030, the UE transmits the interference report to the wireless communication device based on the first interference measurement and the second interference measurement. The interference report may be based on additional measurements if the sequence is repeated more than once. In some aspects, the UE calculates a reflected interference value based on a difference between the first interference measurement and the second interference measurement, and the reflected interference value is included in the interference report. The direct interference value may also be included in the report. In other aspects, the interference report contains only the measurement values. The interference report may be transmitted, for example, via PUSCH or PUCCH, to the wireless communications device (e.g., BS 105, network unit 800, CU 210, DU 230, and/or RU 240).

At block 1035, the UE receives a third message from the wireless communication device based on the interference report. In some aspects, the third message may comprise a scheduled time for the UE to communicate with the passive RF device. For example, based on a determination that interference is above a predetermined threshold when the passive RF device is in a reflective mode. The predetermined threshold may be preconfigured, or dynamically configured by the network unit. The first UE may be scheduled by the third message to communicate with the passive RF device when the aggressor device is not scheduled to transmit. In this way, excessive interference may be avoided.

In other aspects, the third message may comprise an indication to the UE to configure the passive RF device for a non-reflective state at a scheduled time to reduce interference received by the wireless communication device. For example, the third message may have the UE put the passive RF device into a non-reflective state when a BS 105 is scheduled to transmit a downlink message to the UE, or when another aggressor device such as another UE 115 is transmitting and would potentially cause excessive interference.

At block 1040, the UE communicates with the passive RF device based on the third message. For example, the UE transmits and receives a response from the passive RF device at the time scheduled by the third message. In another example, the UE turns the passive RF device off or into another non-reflective state at a time determined by the third message.

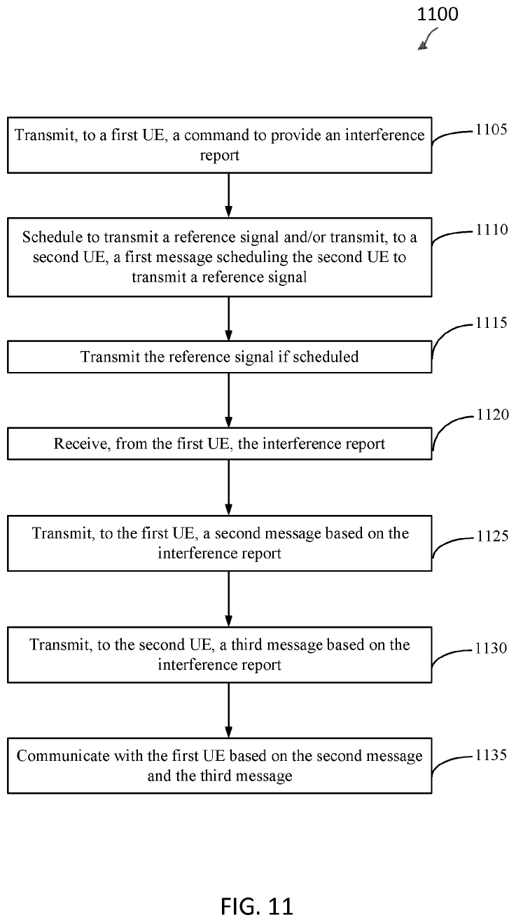

FIG. 11 is a flow diagram illustrating a wireless communication method 1100 according to some aspects of the present disclosure. Aspects of the method 1100 can be executed by a computing device (e.g., a processor, processing circuit, and/or other suitable component) of a wireless communication device or other suitable means for performing the blocks. In one aspect, a BS 105, a CU 210 and/or DU 230, or network unit 800, may perform the method 1100 utilizing components such as the processor 802, the memory 804, the CLI mitigation module 808, the transceiver 810, the modem 812, and the one or more antennas 816 shown in FIG. 8. As illustrated, the method 1100 includes a number of enumerated blocks, but aspects of the method 1100 may include additional blocks before, after, and in between the enumerated blocks. In some aspects, one or more of the enumerated blocks may be omitted or performed in a different order.

At block 1105, a network unit (e.g., BS 105, network unit 800, CU 210, DU 230, and/or RU 240) transmits, to a first UE (e.g., reader 115r, UE 115, UE 900, or other UE), a command to provide an interference report. The network unit may transmit the command in response to a request from the UE, or a determination based on network characteristics. The command may be transmitted, for example via a PDCCH in a DCI message, or via RRC.

At block 1110, the network unit schedules to transmit a reference signal (e.g., CSI-RS) and/or transmit, to a second UE, a first message scheduling the second UE to transmit a reference signal (e.g., SRS). The reference signal transmission may be scheduled for when the first UE will be making interference measurements, so that the UE may measure the level of interference when the network unit and/or another UE 115 is transmitting.

At block 1115, the network unit transmits the reference signal if scheduled. The reference signal may be a CSI-RS. It may be a single reference signal, or a series of reference signals which are transmitted at times when the UE is scheduled to make interference measurements.

At block 1120, the network unit receives, from the first UE, the interference report. The interference report may be based on interference measurements (e.g., RSSI measurements) performed by the UE, where each measurement is performed while a passive RF device is in a reflective or non-reflective state as discussed with reference to FIG. 6. In some aspects, the interference report contains a reflected interference value calculated by the UE based on the interference measurements. The interference report may also include the direct interference value. In other aspects, the measurement values are included in the interference report. The network unit may determine a reflected interference value based on the measurements received in the interference report. The interference report may be received, for example, via PUSCH or PUCCH from the first UE.

At block 1125, the network unit transmits, to the first UE, a second message based on the interference report. In some aspects, the second message may comprise a scheduled time for the UE to communicate with the passive RF device. For example, based on a determination by the network unit that interference is above a predetermined threshold when the passive RF device is in a reflective mode. The predetermined threshold may be preconfigured, or dynamically configured by the network unit. The first UE may be scheduled to communicate with the passive RF device when the aggressor device is not scheduled to transmit based on the second message. In this way, excessive interference may be avoided.

At block 1130, the network unit transmits, to the second UE, a third message based on the interference report. The third message may identify a scheduled time for the second UE to communicate with the network unit. For example, the second UE may be scheduled to communicate with the network unit when the first UE is not scheduled to communicate with the passive RF device. The scheduling may be based on a determination that the second UE is causing interference above a predetermined threshold when the passive RF device is in a reflective state.

At block 1135, the network unit communicates with the first UE based on the second message and the third message. For example, the network unit may communicate with the first UE at a time when the network unit indicated to the first UE to put the passive RF device in a non-reflective state (either powered off, or non-reflecting in some other way), so that the signal from the network unit may be received by the first UE without excessive interference.

Further aspects of the present disclosure include the following:

Aspect 1. A method of wireless communication performed by a user equipment (UE), the method comprising:
transmitting, to a passive radio frequency (RF) device, a first message to enter a non-reflective state;
performing a first interference measurement while the passive RF device is in the non-reflective state;
transmitting, to the passive RF device, a second message to enter a reflective state;
performing a second interference measurement while the passive RF device is in the reflective state; and
transmitting an interference report to a wireless communication device based on the first interference measurement and the second interference measurement.
   Aspect 2. The method of aspect 1, further comprising:
calculating a reflected interference value based on a difference between the first interference measurement and the second interference measurement,
wherein the transmitting the interference report comprises transmitting, to the wireless communication device, the reflected interference value and the first interference measurement.
   Aspect 3. The method of any of aspects 1-2, further comprising:
receiving a third message from the wireless communication device based on the interference report, the third message comprising a scheduled time for the UE to communicate with the passive RF device to reduce interference received by the wireless communication device; and
communicating with the passive RF device according to the scheduled time.
   Aspect 4. The method of any of aspects 1-2, further comprising:
receiving a third message from the wireless communication device based on the interference report indicating to the UE to configure the passive RF device for the non-reflective state at a scheduled time to reduce interference received by the wireless communication device.
   Aspect 5. The method of aspect 4, further comprising:
transmitting, to the passive RF device, a fourth message to enter the non-reflective state according to the third message; and
receiving a fifth message from the wireless communication device while the passive RF device is in the non-reflective state.
   Aspect 6. The method of any of aspects 1-5, wherein the passive RF device is powered off while in the non-reflective state.
   Aspect 7. The method of any of aspects 1-5, wherein the passive RF device is powered on while in the non-reflective state, in a mode which attenuates reflections more than the reflective state.
   Aspect 8. The method of any of aspects 1-7, wherein the first interference measurement and the second interference measurement are respective first and second received signal strength indicator (RSSI) measurements.
   Aspect 9. The method of any of aspects 1-8, wherein the wireless communication device is a base station.
   Aspect 10. The method of any of aspects 1-9, wherein the wireless communication device is a second UE.
   Aspect 11. A method of wireless communication performed by a wireless communication device, the method comprising:
transmitting, to a first user equipment (UE), a command to provide an interference report;
transmitting, to a second UE, a first message scheduling the second UE to transmit a reference signal; and
receiving the interference report from the first UE based on a first interference measurement of the reference signal and a second interference measurement of the reference signal.
   Aspect 12. The method of aspect 11, wherein the interference report includes the first interference measurement and the second interference measurement, further comprising:
calculating a reflected interference value based on a difference between the first interference measurement and the second interference measurement.
   Aspect 13. The method of any of aspects 11-12, further comprising:
transmitting a second message to the second UE based on the interference report,
wherein the second message identifies a scheduled time for the UE to communicate with the wireless communication device.
   Aspect 14. The method of any of aspects 11-13, further comprising:
transmitting a second message to the first UE based on the interference report, the second message comprising a scheduled time for the first UE to communicate with a passive RF device to reduce interference received by the first UE.
   Aspect 15. The method of any of aspects 11-12, further comprising:
transmitting a second message to the first UE based on the interference report indicating to the first UE to configure a passive RF device for a non-reflective state at a scheduled time to reduce interference received by the first UE.
   Aspect 16. The method of any of aspects 11-15, wherein the first interference measurement and the second interference measurement are respective first and second received signal strength indicator (RSSI) measurements.
   Aspect 17. The method of any of aspects 11-16, wherein the first interference measurement and the second interference measurement are measured at different times.
   Aspect 18. The method of any of aspects 11-17, wherein the wireless communication device is a base station.
   Aspect 19. The method of any of aspects 11-18, wherein the wireless communication device is a second UE.
   Aspect 20. A user equipment (UE), comprising:
a transceiver configured to:
   transmit, to a passive radio frequency (RF) device, a first message to enter a non-reflective state;
   perform a first interference measurement while the passive RF device is in the non-reflective state;
   transmit, to the passive RF device, a second message to enter a reflective state;
   perform a second interference measurement while the passive RF device is in the reflective state; and
   transmit an interference report to a wireless communication device based on the first interference measurement and the second interference measurement.
      Aspect 21. The UE of aspect 20, further comprising:
a processor configured to:
calculate a reflected interference value based on a difference between the first interference measurement and the second interference measurement,
wherein the transmitting the interference report comprises transmitting, to the wireless communication device, the reflected interference value and the first interference measurement.
   Aspect 22. The UE of any of aspects 20-21, wherein the transceiver is further configured to:
receive a third message from the wireless communication device based on the interference report, the third message comprising a scheduled time for the UE to communicate with the passive RF device to reduce interference received by the wireless communication device; and
communicate with the passive RF device according to the scheduled time.
   Aspect 23. The UE of any of aspects 20-21, wherein the transceiver is further configured to:
receive a third message from the wireless communication device based on the interference report indicating to the UE to configure the passive RF device for the non-reflective state at a scheduled time to reduce interference received by the wireless communication device.
   Aspect 24. The UE of aspect 23, wherein the transceiver is further configured to:
transmit, to the passive RF device, a fourth message to enter the non-reflective state according to the third message; and
receive a fifth message from the wireless communication device while the passive RF device is in the non-reflective state.
   Aspect 25. The UE of any of aspects 20-24, wherein the passive RF device is powered off while in the non-reflective state.
   Aspect 26. The UE of any of aspects 20-24, wherein the passive RF device is powered on while in the non-reflective state, in a mode which attenuates reflections more than the reflective state.
   Aspect 27. A wireless communication device, comprising:
a transceiver configured to:
   transmit, to a first user equipment (UE), a command to provide an interference report;
   transmit, to a second UE, a first message scheduling the second UE to transmit a reference signal; and
   receive the interference report from the first UE based on a first interference measurement of the reference signal and a second interference measurement of the reference signal.
      Aspect 28. The wireless communication device of aspect 27, wherein the interference report includes the first interference measurement and the second interference measurement, further comprising:
a processor configured to calculate a reflected interference value based on a difference between the first interference measurement and the second interference measurement.
   Aspect 29. The wireless communication device of any of aspects 27-28, wherein the transceiver is further configured to:
transmit a second message to the second UE based on the interference report,
wherein the second message identifies a scheduled time for the UE to communicate with the wireless communication device.
   Aspect 30. The wireless communication device of any of aspects 27-29, wherein the transceiver is further configured to:
transmit a second message to the first UE based on the interference report, the second message comprising a scheduled time for the first UE to communicate with a passive RF device to reduce interference received by the first UE.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular aspects illustrated and described herein, as they are merely by way of some examples thereof, but rather, should be fully commensurate with that of the claims appended hereafter and their functional equivalents.

1. A method of wireless communication performed by a user equipment (UE), the method comprising:
transmitting, to a passive radio frequency (RF) device, a first message to enter a non-reflective state;
performing a first interference measurement while the passive RF device is in the non-reflective state;
transmitting, to the passive RF device, a second message to enter a reflective state;
performing a second interference measurement while the passive RF device is in the reflective state; and
transmitting an interference report to a wireless communication device based on the first interference measurement and the second interference measurement.

2. The method of claim 1, further comprising:
calculating a reflected interference value based on a difference between the first interference measurement and the second interference measurement,
wherein the transmitting the interference report comprises transmitting, to the wireless communication device, the reflected interference value and the first interference measurement.

3. The method of claim 1, further comprising:
receiving a third message from the wireless communication device based on the interference report, the third message comprising a scheduled time for the UE to communicate with the passive RF device to reduce interference received by the wireless communication device; and
communicating with the passive RF device according to the scheduled time.

4. The method of claim 1, further comprising:
receiving a third message from the wireless communication device based on the interference report indicating to the UE to configure the passive RF device for the non-reflective state at a scheduled time to reduce interference received by the wireless communication device.

5. The method of claim 4, further comprising:
transmitting, to the passive RF device, a fourth message to enter the non-reflective state according to the third message; and
receiving a fifth message from the wireless communication device while the passive RF device is in the non-reflective state.

6. The method of claim 1, wherein the passive RF device is powered off while in the non-reflective state.

7. The method of claim 1, wherein the passive RF device is powered on while in the non-reflective state, in a mode which attenuates reflections more than the reflective state.

8. The method of claim 1, wherein the first interference measurement and the second interference measurement are respective first and second received signal strength indicator (RSSI) measurements.

9. The method of claim 1, wherein the wireless communication device is a base station.

10. The method of claim 1, wherein the wireless communication device is a second UE.

11. A method of wireless communication performed by a wireless communication device, the method comprising:
transmitting, to a first user equipment (UE), a command to provide an interference report;
transmitting, to a second UE, a first message scheduling the second UE to transmit a reference signal; and
receiving the interference report from the first UE based on a first interference measurement of the reference signal and a second interference measurement of the reference signal.

12. The method of claim 11, wherein the interference report includes the first interference measurement and the second interference measurement, further comprising:
calculating a reflected interference value based on a difference between the first interference measurement and the second interference measurement.

13. The method of claim 11, further comprising:
transmitting a second message to the second UE based on the interference report,
wherein the second message identifies a scheduled time for the UE to communicate with the wireless communication device.

14. The method of claim 11, further comprising:
transmitting a second message to the first UE based on the interference report, the second message comprising a scheduled time for the first UE to communicate with a passive RF device to reduce interference received by the first UE.

15. The method of claim 11, further comprising:
transmitting a second message to the first UE based on the interference report indicating to the first UE to configure a passive RF device for a non-reflective state at a scheduled time to reduce interference received by the first UE.

16. The method of claim 11, wherein the first interference measurement and the second interference measurement are respective first and second received signal strength indicator (RSSI) measurements.

17. The method of claim 11, wherein the first interference measurement and the second interference measurement are measured at different times.

18. The method of claim 11, wherein the wireless communication device is a base station.

19. The method of claim 11, wherein the wireless communication device is a second UE.

20. A user equipment (UE), comprising:
a transceiver configured to:
transmit, to a passive radio frequency (RF) device, a first message to enter a non-reflective state;
perform a first interference measurement while the passive RF device is in the non-reflective state;
transmit, to the passive RF device, a second message to enter a reflective state;
perform a second interference measurement while the passive RF device is in the reflective state; and
transmit an interference report to a wireless communication device based on the first interference measurement and the second interference measurement.

21. The UE of claim 20, further comprising:
a processor configured to:
calculate a reflected interference value based on a difference between the first interference measurement and the second interference measurement,
wherein the transmitting the interference report comprises transmitting, to the wireless communication device, the reflected interference value and the first interference measurement.

22. The UE of claim 20, wherein the transceiver is further configured to:
receive a third message from the wireless communication device based on the interference report, the third message comprising a scheduled time for the UE to communicate with the passive RF device to reduce interference received by the wireless communication device; and
communicate with the passive RF device according to the scheduled time.

23. The UE of claim 20, wherein the transceiver is further configured to:
receive a third message from the wireless communication device based on the interference report indicating to the UE to configure the passive RF device for the non-reflective state at a scheduled time to reduce interference received by the wireless communication device.

24. The UE of claim 23, wherein the transceiver is further configured to:
transmit, to the passive RF device, a fourth message to enter the non-reflective state according to the third message; and
receive a fifth message from the wireless communication device while the passive RF device is in the non-reflective state.

25. The UE of claim 20, wherein the passive RF device is powered off while in the non-reflective state.

26. The UE of claim 20, wherein the passive RF device is powered on while in the non-reflective state, in a mode which attenuates reflections more than the reflective state.

27. A wireless communication device, comprising:
a transceiver configured to:
transmit, to a first user equipment (UE), a command to provide an interference report;
transmit, to a second UE, a first message scheduling the second UE to transmit a reference signal; and
receive the interference report from the first UE based on a first interference measurement of the reference signal and a second interference measurement of the reference signal.

28. The wireless communication device of claim 27, wherein the interference report includes the first interference measurement and the second interference measurement, further comprising:
a processor configured to calculate a reflected interference value based on a difference between the first interference measurement and the second interference measurement.

29. The wireless communication device of claim 27, wherein the transceiver is further configured to:
transmit a second message to the second UE based on the interference report,
wherein the second message identifies a scheduled time for the UE to communicate with the wireless communication device.

30. The wireless communication device of claim 27, wherein the transceiver is further configured to:
transmit a second message to the first UE based on the interference report, the second message comprising a scheduled time for the first UE to communicate with a passive RF device to reduce interference received by the first UE.
